(19) United States
(12) Patent Application Publication
(10) Pub. No.: US 2017/0044773 A1
(43) Pub. Date: Feb. 16, 2017

(54) Acoustic Leveling Clip

(71) Applicant: Michael Gernhart, Las Vegas, NV (US)

(72) Inventor: Michael Gernhart, Las Vegas, NV (US)

(21) Appl. No.: 15/233,694

(22) Filed: Aug. 10, 2016

Related U.S. Application Data
(60) Provisional application No. 62/204,361, filed on Aug. 12, 2015.

(51) Int. Cl. E04F 13/08; E04B 1/84; F16M 13/02; E04B 1/41

(52) U.S. Cl. CPC E04F 13/0807; E04B 1/40; E04B 1/84; F16M 13/02; F16M 13/027

(57) ABSTRACT

An acoustic leveling clip includes an insert formed from a flexible, acoustically insulating material. The insert includes a flanged end and cylindrical body having male threads. The leveling clip further includes a mounting clip that has an aperture and female threads. The cylindrical body of the insert is configured to extend through the aperture. In this manner, the mounting clip is movable along the cylindrical body of the insert by way of the male threads and the female threads.

### CROSS REFERENCE TO RELATED APPLICATION

This application claims priority to U.S. Provisional Application No. 62/204,361 which was filed on Aug. 12, 2015, the contents of which are hereby incorporated by reference.

### BACKGROUND

1. Field

The disclosed embodiments relate to acoustic isolation in structures and the leveling of walls, floors, and ceilings. More specifically, the disclosed embodiments relate to an acoustic leveling clip that provides the ability to simultaneously level a surface of a wall, floor, or ceiling while also providing acoustic insulation and isolation.

2. Related Art

Building structures conventionally have living spaces separated by walls, floors, and ceilings. Such walls, floors, and ceilings may be framed walls using metal or wooden studs. Other walls, floors, and ceilings may be made of concrete, such as reinforced concrete. Often, a thinner, lighter wall surface, such as plasterboard or gypsum board, is used to cover the wall, floor, or ceiling. The lighter wall surface may be attached to the wall, floor, or ceiling directly or through mounting brackets that maintain a gap between the wall and the lighter wall surface.

Such wall systems may suffer from a number of drawbacks. One such problem is that the wall may not be adequately level. For example, at least one side of a concrete wall may not have a level or true surface after it is constructed. Similarly, wood or metal studs may be warped or may be slightly bent due to manufacturing or during the framing process.

In order to solve this problem, leveling clips have been developed that allow an uneven wall to be leveled. An array of such leveling clips may be mounted to the wall on which a level surface can be attached. The lighter wall surface, such as the gypsum board, may then be attached to the leveling clips, thus forming a level surface. The leveling clips therefore serve to correct the imperfections in the wall so that the attached lighter wall surface can appear flat and unblemished.

Another problem of typical wall systems is that sound is easily transmitted through the walls, floors, or ceiling. This results in outside noise or noise from another room entering into a work or living space. Many efforts are taken to reduce the transfer of such noise such as by providing insulation or acoustically isolating the lighter wall surface from the wall, floor, or ceiling structure.

One such solution is described in U.S. Pat. No. 6,267,347. There, an acoustic mount including a mount clip, a sound absorbing insert, and a bushing are used to isolate a first part from acoustic vibrations existing in a second part. The effect of the acoustic mount is to effectively ameliorate, if not entirely suppress, low frequency noise transmission between two parts of a particular construct.

While the above two problems thus have effective solutions individually, it remains difficult to achieve a solution to both problems simultaneously. For example, while the acoustic mount disclosed in U.S. Pat. No. 6,267,347 provides excellent acoustic isolation, it is difficult to also incorporate a leveling clip in order to simultaneously level a wall. Further, typical leveling clips themselves provide little to no acoustical isolation. With increasing demand for prime office, retail, convention, hotel, and residential spaces, there is a need to simultaneously provide truly level floors, walls, and ceilings as well as acoustic isolation.

### SUMMARY

The disclosed embodiments have been developed in light of the above, and aspects of the invention may include a leveling clip that provides high-performance acoustical isolation. Other aspects include methods for using acoustic leveling clips, and methods for manufacturing acoustic leveling clips.

According to one embodiment of the invention, an acoustic leveling clip is provided that includes an insert formed from a flexible, acoustically insulating material. The insert may include a flanged end and cylindrical elongated body. The cylindrical elongated body may be configured to have male threads. The leveling clip may further include a mounting clip that has an aperture. In some embodiments, the aperture may have female threads to correspond with the male threads of the insert. The cylindrical body of the insert is configured to extend through the aperture. In this manner, the mounting clip is movable along the cylindrical body of the insert, for example, by way of the male threads and the female threads.

In some embodiments, the acoustically insulating material of the insert comprises a rubber material, a synthetic rubber, a softened PVC, EPDM, or neoprene. The acoustically insulating material may comprise a durometer hardness between 20 and 60 or more particularly between 30 and 50. In some embodiments, the male threads of the insert may be buttressed threads. In one example, the buttressed threads are 45/5 buttressed threads.

The cylindrical elongated body may comprise an elongated non-threaded portion and a threaded portion. There may be a second flange disposed on an opposite end of the elongated non-threaded portion from the first flange and adjacent to the threaded portion of the cylindrical body. In other embodiments, the cylindrical body comprises a threaded portion and a tapered portion.

In some embodiments, the mounting clip has attachment flanges. The attachment flanges are configured to position a furring channel to which a wall surface material may be mounted.

In another exemplary embodiment, there is a system for leveling and acoustically isolating a wall, floor, or ceiling comprising a plurality of inserts formed from a flexible, acoustically insulating material. The inserts may have a flanged end and an elongated body. The system may further include a plurality of mounting clips that have an aperture. The elongated body of the inserts are inserted into the aperture. The mounting clips are positionable at a plurality of locations along the elongated body of the inserts. A furring channel may then attach to two or more of the plurality of mounting clips.

The system may further comprise fasteners that attach the plurality of inserts to the wall. The furring channels are configured to support the surface material of the wall, floor, or ceiling that is mounted to the furring channels. The position of the surface material and the furring channels is set based on positions of the mounting clips with respect to the elongated body of the inserts. The plurality of mounting clips may comprise attachment flanges to which the furring channel attaches.

In another exemplary embodiment, there is a method for leveling and acoustically isolating a wall, floor, or ceiling. The method comprises providing a plurality of inserts formed from a flexible, acoustically insulating material. The inserts may include a flanged end and an elongated body. A plurality of mounting clips that include an aperture are also provided. The elongated body of the inserts are placed into the apertures of the mounting clips so that the mounting clips are positionable at a plurality of locations along the elongated body of the inserts.

The plurality of inserts may then be fastened onto the wall, floor, or ceiling. A furring channel is attached to two or more of the plurality of mounting clips, and a surface material is mounted onto the furring channel. The positions of the surface material and the furring channel are set based on positions of the mounting clips with respect to the elongated body of the inserts.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 shows a side view of an acoustic isolating leveling clip, according to one embodiment.

FIG. 2 shows a perspective view of an acoustic isolating leveling clip, according to one embodiment.

FIG. 3 shows buttressed threads of an acoustic isolating leveling clip, according to one embodiment.

FIG. 4 shows an array of acoustic isolating leveling clips in operation, according to one embodiment.

FIG. 5 shows adjustment of an acoustic isolating leveling clip, according to one embodiment.

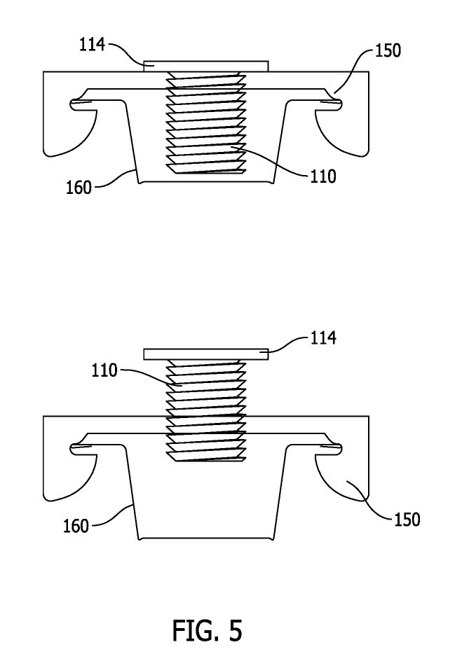

FIG. 6A and FIG. 6B show a leveling clip utilizing an L-bracket, according to one exemplary embodiment.

FIG. 7 shows example embodiments of inserts for an acoustic isolating leveling clip.

FIG. 8 shows a floor ceiling assembly test setup for an acoustic isolating leveling clip.

FIG. 9 shows test results for the setup shown in FIG. 8.

FIG. 10 shows test results for the setup shown in FIG. 8.

FIG. 11 shows a wall assembly test setup for an acoustic isolating leveling clip.

FIG. 12 shows test results for the test setup shown in FIG. 11.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

The disclosed embodiments include an acoustic leveling clip, methods for using an acoustic leveling clip, and methods for manufacturing an acoustic leveling clip. According to the embodiments, an acoustic leveling clip is provided which may simultaneously allow a user to level a wall, floor, or ceiling such that an attached wall surface, for example gypsum board, may be configured to be level while also providing high-performance acoustic isolation of the attached wall surface.

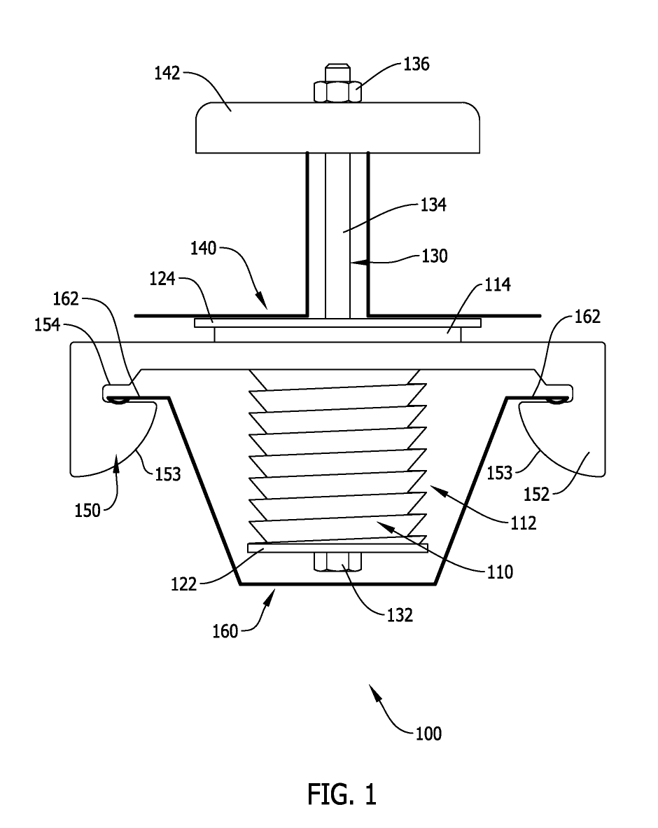

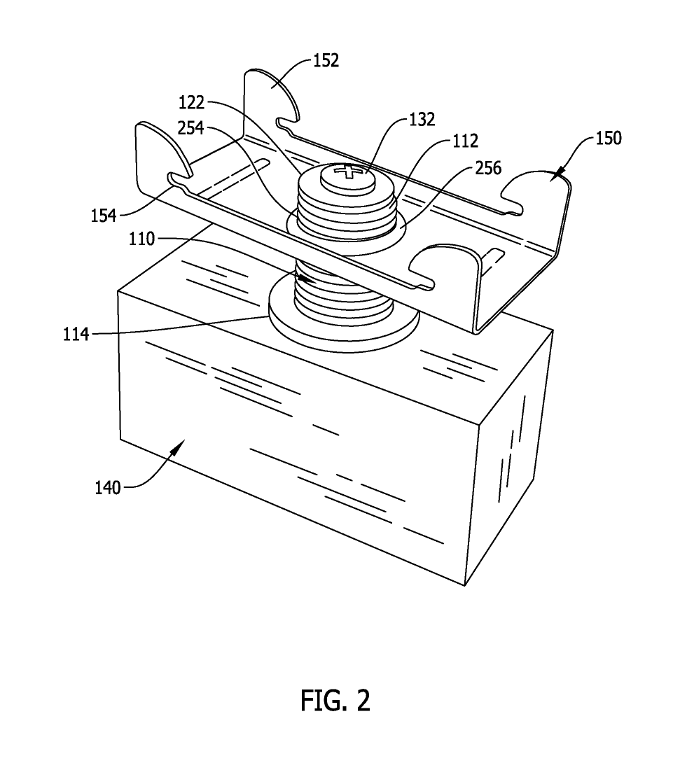

FIG. 1 shows a side view of an acoustic leveling clip, and FIG. 2 shows a perspective view of an acoustic leveling clip, according to one embodiment. In this embodiment, an acoustic leveling clip 100 comprises an insert 110, and a mounting clip 150. The insert 110 includes a flange 114 on a first end and a plurality of threads 112 that extend from the flange 114 to the second end. The insert 110 further includes a through-hole (not shown) disposed in the center of the first end and the second end and that extends from the first end through to the second end of the insert 110.

The insert 110 is preferably formed from a sound absorbing material. In this embodiment, the insert may be formed from a rubber material, a synthetic rubber, a softened PVC, EPDM, neoprene, or the like. The material serves both to absorb acoustical vibrations as well as provide adequate structural support for the acoustic leveling clip 100. The insert may be formed by any suitable process such as by injection molding. In order to provide the best possible acoustic isolation, the insert 110 preferably has a durometer hardness between 20 and 60, and more preferably between 30 and 50.

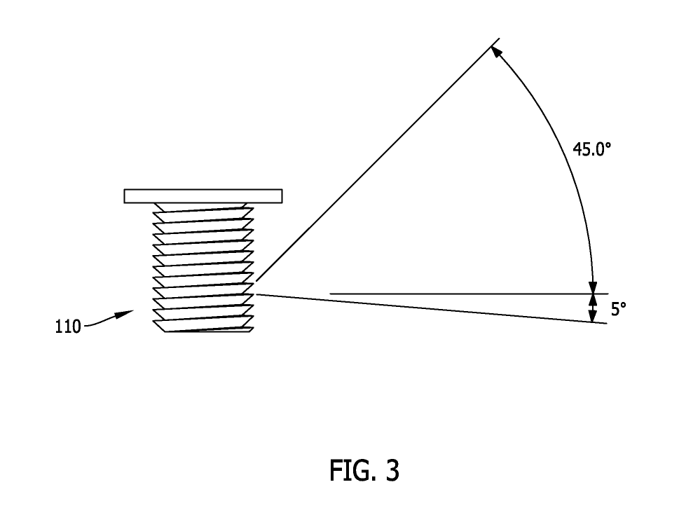

When a sound absorbent material as described above is utilized for the insert 110, the threads 112 are formed so as to ensure the mounting clip 150 stays within the threads 112 and cannot be forced over the threads 112. In one embodiment, the threads 112 are formed as buttressed threads. That is, the threads 112 include a horizontal surface extending outward from the shaft of the insert 110 as shown in FIG. 1. In one embodiment, the insert 110 may be shaped to have a 45/5 buttressed thread, as shown in FIG. 3. This substantially horizontal surface in the buttressed threads prevents the mounting clip 150 from slipping over the threads 112, even when the sound absorbent material is utilized. In this manner, even though the threads 112 are formed from the sound absorbent material (which is typically a flexible material) the threads 112 and the insert 110 have sufficient strength. In an alternate embodiment, the threads 112 may be constructed separately from a hard material and then may be placed over the shaft of the insert 110.

The mounting clip 150 is a substantially rectangular, planar member that includes projections 152 at each end. The projections may include a curved surface 153 that culminates in a groove 154 at the base of the projection 152. The mounting clip 150 further has an aperture 254 with a female thread 256 (see FIG. 2) that is configured to thread onto the male threads 112 of the insert 110. The mounting clip 150 is formed from any suitable material including steel, aluminum, plastics, or composite materials. The mounting clip 150 may be formed, for example, by stamping a blank of sheet metal having a predetermined thickness and forming the blank into the desired shape.

In other embodiments, other fastening mechanisms between the insert 110 and the mount clip 150 may be utilized in place of the threads. For example, the mounting clip 150 may be configured to be press fit over the insert 110. In other embodiments, the insert 110 may be manufactured to be preformed within the mounting clip at one of a plurality of different positions relative to the flange 114. Other now known or later developed fastening mechanisms may also be utilized.

The insert 110 is configured to be affixed and abutted next to a surface 140. The surface 140 may be a wall, floor, or ceiling of a structure and may be made of concrete, wood, steel, or the like. The insert 110 is attached to the surface 140 via a fastener 130. The fastener 130 may vary based on the type of surface, and may include a shaft 134 that may optionally include threads. The fastener 130 may have a head 132 and may optionally include a nut 136 to secure the fastener 130 in place. An anchoring material 142 may also be utilized on an opposite side of the surface 140 of the wall, floor, or ceiling. In one embodiment, washers 122, 124 may be disposed on each end of the insert 110.

The acoustic leveling clip 100 is configured to attach to a furring channel 160. The furring channel 160 comprises flanges 162 that are configured to fit within the grooves 154 of the mounting clip 150. The furring channel 160 extends between two more mounting clips 150 of separate acoustic leveling clips 110.

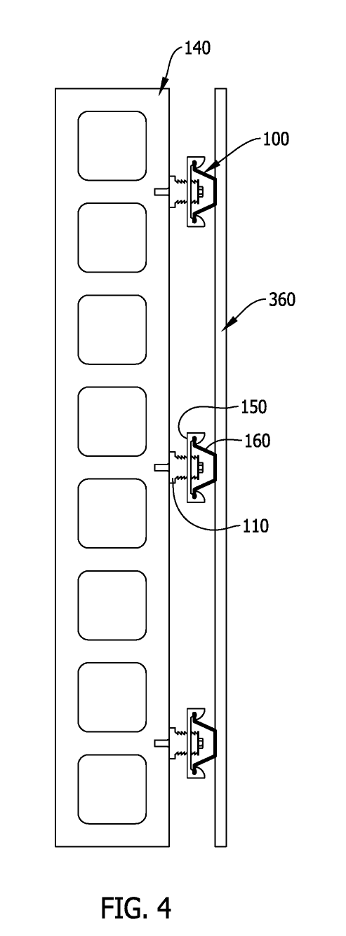

FIG. 3 shows an array of acoustic leveling clips in operation, according to one embodiment. In this embodiment, a plurality of acoustic leveling clips 100 are attached to a surface 140. Mounting clips 150 are attached to the inserts 110 so that furring channels 160 may be attached to the mounting clips 150. In FIG. 3, the furring channels 160 would extend in a direction perpendicular to the plane shown in FIG. 3. The mounting clips 150 are rotated along the threads 112 of the inserts 110 so that when the furring channels 160 are attached to the clips 150, the furring channels 160 are level with one another. For example, as shown in FIG. 4, the mounting clip 150 may be placed on the insert 110 at varying distances from the flange 114. The clips 150 are adjusted until they are positions so that the furring channels 160 running along the row of mounting clips 150 are level. Once the furring channels are so positioned, a wall material 360, such gypsum board, is installed by fastening the wall material 360 to the furring channels 160 (FIG. 3).

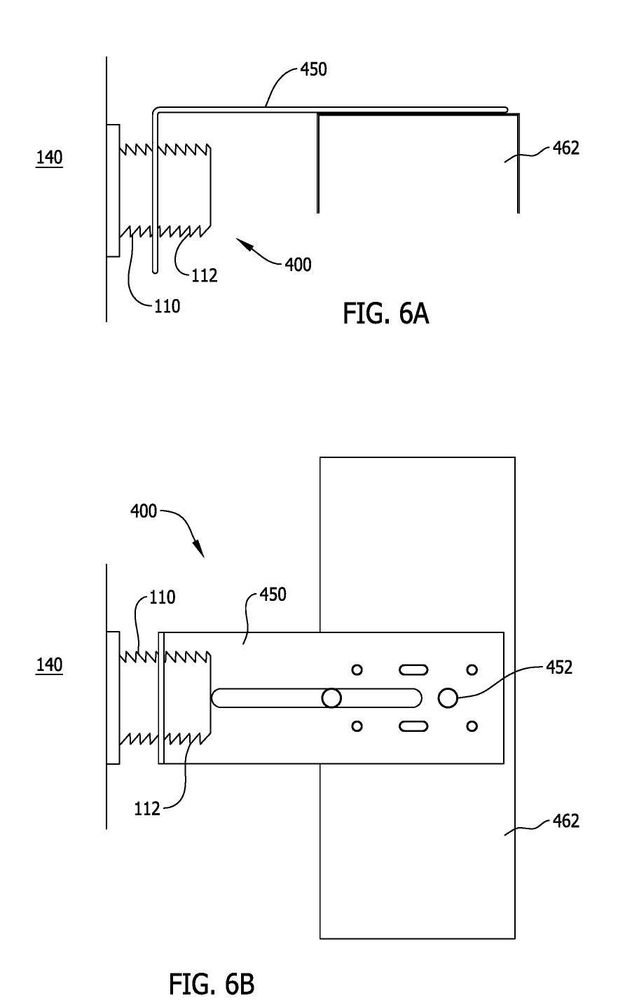

The leveling clip 100 is not limited to the above embodiments, and other variations may be implemented. FIGS. 6A and 6B show a leveling clip utilizing an L-bracket, according to one exemplary embodiment. In this embodiment, a leveling clip 400 includes an L-bracket 450. The L-bracket 450 is threaded onto the insert 110 via the threads 112. In this manner, a plurality of leveling clips 400 may be utilized to level and acoustically isolate a surface 462 from the wall, floor, or ceiling structure 140. Other brackets in addition to the previous mentioned clip 150 and L-bracket 450 could also be used.

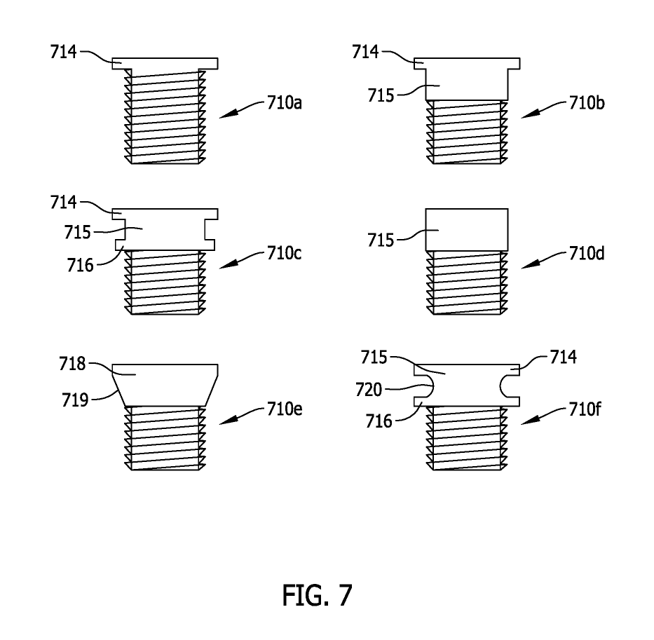

The insert may also be configured in any number of ways. As shown in FIG. 7, the insert 710a may have one end with a flange 714 similar to the insert 110 described above. In another embodiment, an insert 710b may also comprise a flange 714 at one end thereof. Further, the insert 710b comprises an elongated portion 715 extending from the flange 714. The elongated portion 715 acts as a spacer to set a minimum distance between the wall and the mounting clip and furring channel.

In another embodiment, an insert 710c may be provided. Insert 710c also has a flange 714 on an end thereof and an elongated portion 715. Additionally, a second flange 716 is disposed on an opposite end of the elongated portion 715 from the flange 714. In this embodiment, the flange 714 may rest against the surface of the wall while the flange 716 acts as a stopper for the mounting clip.

There may further be an insert 710d. Insert 710d includes an elongated portion 715 without any flanges. In another embodiment, an insert 710e is provided that comprises a tapered portion 718 on one side thereof. The tapered portion includes a tapered edge 719 extending from one side of the insert 710e. Finally, insert 710f may be provided in one embodiment. Here, the insert 710f comprises an elongated portion 715 with flanges 714 and 716. A rounded surface 720 is provided between the flanges 714, 716. Other configurations may also be possible and within the scope of the disclosed embodiments.

The above described embodiments have a number of advantages. For example, because the mounting clip 150 is supported by the threads 112 of the insert 110, the mounting clip may be rotated to change a relative distance between the surface 140 of the wall, floor, or ceiling and the mounting clip 150. In this manner, utilizing an array of leveling clips 100, the wall material 360 can by mounted to a level plane created by the furring channels 160, increasing the appeal of a room such as a living space.

Furthermore, with the insert 110 being constructed of a sound absorbent material, acoustic vibrations from the surface 140 can be prevented from propagating through to the wall material 360. That is, the insert 110 acoustically isolates the wall material 360 from the surface 140.

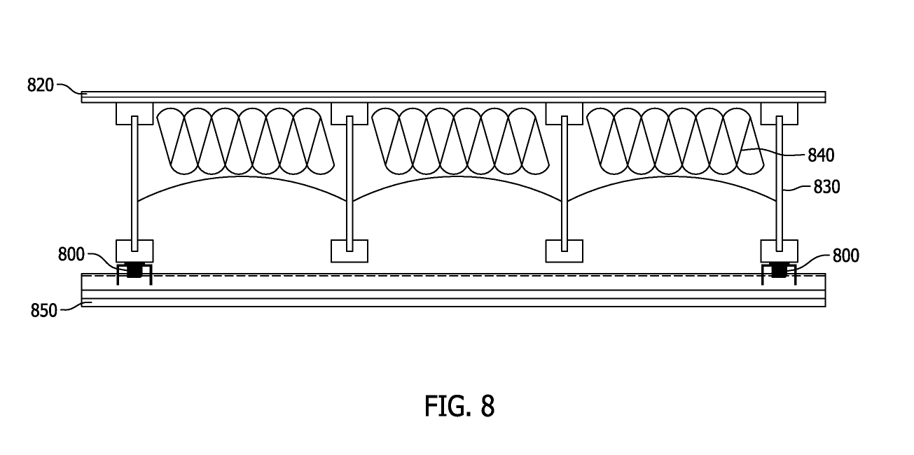

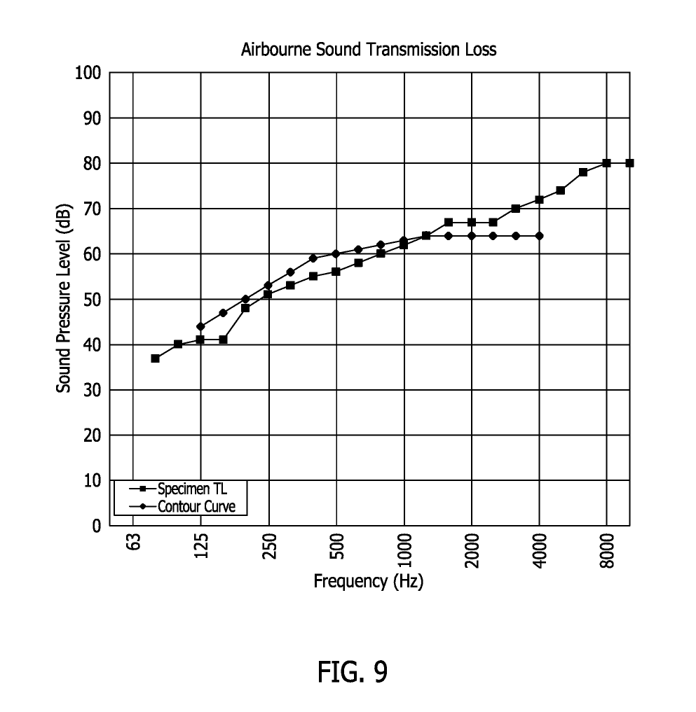

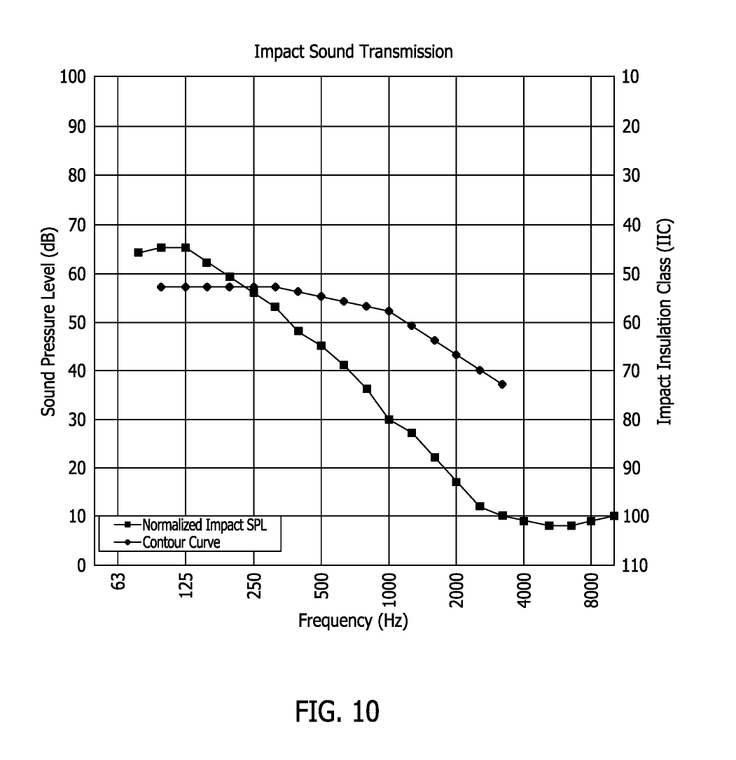

The acoustic isolating leveling clip has been shown to provide superior results in testing. The acoustic isolating leveling clip was tested in a floor ceiling assembly being directly fixed to an I joist. The setup of this test is shown in FIG. 8. Here, the top layer (floor) 820 is formed of two layers of ⅝″ plywood with a waterproof membrane (15 lb felt) between them. 12″ Deep @ 24″ OC “I” joists 830 extend from the floor 820. The acoustic isolating leveling clips 800 are attached to the “I” joists 830, and a ceiling panel 850 comprising two layers of ⅝″ fire code “C” gypsum board are attached to the acoustic leveling clips 800. The clips 800 were tested both for the airborne sound transmission loss and impact sound transmission. The results of the testing is shown in tables 1 and 2 below, and in FIGS. 9 and 10.

TABLE 1
Airborne Sound Transmission Loss

| | Background | | Source | Receive | Specimen | 95% | |
|---|---|---|---|---|---|---|---|
| Freq | SPL | Absorption | SPL | SPL | TL | Confidence | Number of |
| (Hz) | (dB) | (m2) | (dB) | (dB) | (dB) | Limit | Deficiencies |
| 80 | 61.9 | 16.4 | 107 | 69 | 37 | 3.3 | — |
| 100 | 41.2 | 11.8 | 106 | 67 | 40 | 2.2 | — |
| 125 | 37.7 | 9.7 | 104 | 65 | 41 | 1.5 | 3 |
| 160 | 38.1 | 9.4 | 106 | 67 | 41 | 1.6 | 6 |
| 200 | 30.0 | 10.5 | 105 | 58 | 48 | 1.2 | 2 |
| 250 | 29.5 | 10.7 | 105 | 55 | 51 | .6 | 2 |
| 315 | 29.7 | 9.6 | 105 | 53 | 53 | .7 | 3 |
| 400 | 28.3 | 9.2 | 104 | 51 | 55 | .7 | 4 |
| 500 | 26.7 | 8.7 | 104 | 50 | 56 | .6 | 4 |
| 630 | 26.7 | 8.4 | 105 | 49 | 58 | .5 | 3 |
| 800 | 27.8 | 8.7 | 105 | 46 | 60 | .5 | 2 |
| 1000 | 26.1 | 8.8 | 104 | 44 | 62 | .5 | 1 |
| 1250 | 25.9 | 8.8 | 105 | 43 | 64 | .5 | 0 |
| 1600 | 22.7 | 8.8 | 105 | 41 | 67 | .5 | 0 |
| 2000 | 15.8 | 9.7 | 105 | 39 | 67 | .5 | 0 |
| 2500 | 10.5 | 10.8 | 104 | 38 | 67 | .3 | 0 |
| 3150 | 9.1 | 12.1 | 104 | 34 | 70 | .4 | 0 |
| 4000 | 7.8 | 13.9 | 103 | 31 | 72 | .7 | 0 |
| 5000 | 6.2 | 16.7 | 103 | 28 | 74 | .9 | — |
| 6300 | 6.3 | 21.2 | 97 | 17 | 78 | .7 | — |
| 8000 | 6.3 | 28.5 | 96 | 13 | 80 | 1.00 | — |
| 10000 | 6.2 | 35.7 | 91 | 7 | 80 | .9 | — |

TABLE 2
Impact Sound Transmission

| | Back- | | | 95% | |
|---|---|---|---|---|---|
| | ground | | Normalized | Con- | |
| Freq | SPL | Absorption | Impact SPL | fidence | Number of |
| (Hz) | (dB) | (m2) | (dB) | Limit | Deficiencies |
| 80 | 61.8 | 16 | 64 | 2.5 | — |
| 100 | 43.8 | 14 | 65 | 1.4 | 8 |
| 125 | 38.7 | 10 | 65 | 3.0 | 8 |
| 160 | 37.6 | 9 | 62 | 1.9 | 5 |
| 200 | 30.3 | 10 | 59 | 1.5 | 2 |
| 250 | 30.1 | 11 | 56 | 1 | 0 |
| 315 | 30.7 | 10 | 53 | 0.6 | 0 |
| 400 | 28.2 | 9 | 48 | 0.9 | 0 |
| 500 | 26.0 | 9 | 45 | 0.6 | 0 |
| 630 | 27.0 | 9 | 41 | 0.4 | 0 |
| 800 | 27.6 | 9 | 36 | 0.2 | 0 |
| 1250 | 25.2 | 9 | 27 | 0.3 | 0 |
| 1600 | 21.9 | 9 | 22 | 0.1 | 0 |
| 2000 | 15.2 | 10 | 17 | 0.2 | 0 |
| 2500 | 10.8 | 11 | 12 | 0.5 | 0 |
| 3150 | 9.6 | 12 | 10 | 0.5 | 0 |
| 4000 | 7.8 | 14 | 9 | 0.5 | — |
| 5000 | 6.0 | 17 | 8 | 0.5 | — |
| 6300 | 6.1 | 21 | 8 | 0.8 | — |
| 8000 | 6.2 | 28 | 9 | 0.9 | — |
| 10000 | 6.4 | 35 | 10 | 0.9 | — |

Thus, the acoustic isolating leveling clip provides substantial acoustic isolation. Based on the test results, the isolating leveling clip in this configuration has a Sound Transmission Class (STC) rating of 60 and an Impact Insulation Class (IIC) rating of 55.

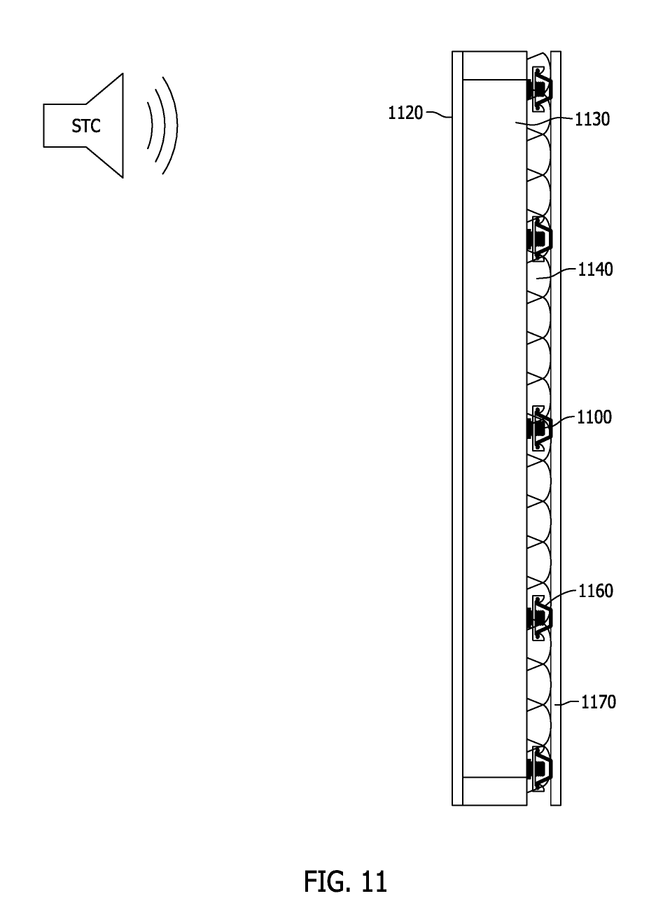

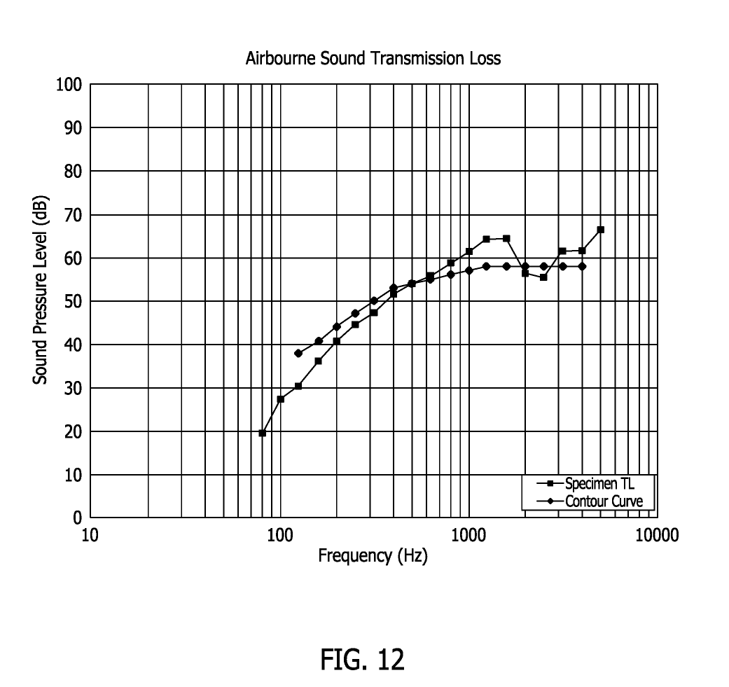

The isolating leveling clip was also tested in a wall assembly directly fixed to a wood stud, as shown in FIG. 11. Here, one layer of ⅝″ gypsum board is attached to framed 2×4 wood studs 1130 spaced 16″ apart. 5.5″ of insulation 1140 is placed between the studs 1130. Acoustic isolating leveling clips 1100 are directly attached to the studs 1130. A ⅞″×25 gauge furring channel 1160 is attached to the leveling clips 1100. A second ⅝″ layer of gypsum board is attached to the furring channels 1160. The results of these tests are shown in Table 3 below, as well as in FIG. 12.

TABLE 3
Airborne Sound Transmission Loss

| | Background | | Source | Receive | Specimen | 95% | |
|---|---|---|---|---|---|---|---|
| Freq | SPL | Absorption | SPL | SPL | TL | Confidence | Number of |
| (Hz) | (dB) | (m2) | (dB) | (dB) | (dB) | Limit | Deficiencies |
| 80 | 39.2 | 4.9 | 105 | 86 | 19.5 | 2.08 | — |
| 100 | 36.8 | 4.6 | 106 | 79 | 27.4 | 1.98 | — |
| 125 | 39.1 | 4.8 | 106 | 76 | 30.4 | 1.64 | 8 |
| 160 | 42.5 | 4.6 | 107 | 72 | 36.1 | 0.94 | 5 |
| 200 | 40.9 | 4.7 | 107 | 67 | 40.8 | 0.78 | 3 |
| 250 | 35.6 | 4.9 | 106 | 63 | 44.5 | 0.71 | 3 |
| 315 | 28.4 | 5.4 | 102 | 55 | 47.2 | 0.39 | 3 |
| 400 | 24.4 | 5.5 | 101 | 50 | 51.5 | 0.34 | 1 |
| 500 | 20.9 | 5.8 | 101 | 47 | 53.9 | 0.52 | 0 |
| 630 | 18.5 | 5.6 | 101 | 46 | 55.7 | 0.26 | 0 |
| 800 | 16.7 | 5.7 | 102 | 43 | 58.7 | 0.30 | 0 |
| 1000 | 13.0 | 5.9 | 100 | 39 | 61.3 | 0.16 | 0 |
| 1250 | 10.3 | 6.7 | 98 | 33 | 64.1 | 0.26 | 0 |
| 1600 | 8.3 | 7.0 | 101 | 37 | 64.3 | 0.29 | 0 |
| 2000 | 6.2 | 7.5 | 100 | 43 | 56.3 | 0.13 | 2 |
| 2500 | 6.2 | 8.5 | 98 | 41 | 55.4 | 0.20 | 3 |
| 3150 | 6.3 | 10.0 | 98 | 35 | 61.4 | 0.16 | 0 |
| 4000 | 7.0 | 12.0 | 97 | 33 | 61.6 | 0.35 | 0 |
| 5000 | 7.6 | 15.5 | 95 | 25 | 66.3 | 0.31 | — |

Based on the test results, the isolating leveling clip in this configuration has an STC rating of 54 and an Outdoor-Indoor Transmission Class (OITC) rating of 37. In both arrangements, the acoustic leveling clip provides significantly enhanced acoustic isolation when compared with a typical insulated wall (STC rating of approximately 36 to 39).

Furthermore, because the leveling clip allows the distance between the wall or ceiling and the furring channel to be variable in order to level the wall, the leveling clip allows acoustical tuning. That is, by changing the distance of the outer wall, floor, or ceiling surface with respect to the underlying structure, the acoustic isolating clip may be more effective for isolating specific frequencies. This allows the wall to be tuned to specific known frequencies that may exist in an environment surrounding the room, thereby achieving even greater acoustic isolation for the room.

The leveling clip 100 provides additional advantages. For example, the leveling clip 100 may decrease the amount of heat transfer through the wall, floor, or ceiling. In conventional buildings, insulation is effective at providing thermal insulation. However, heat may still be transferred around the insulation through the wall structure and to the lighter wall surface. With the leveling clip 100, the lighter wall surface, such as the gypsum board, is also thermally isolated from the wall, floor, or ceiling structure, enhancing the thermal properties of the room.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An acoustic leveling clip comprising:
an insert formed from a flexible, acoustically insulating material, the insert comprising a an elongated body; and
a mounting clip that includes an aperture, the elongated body of the insert being received in the aperture, and the mounting clip being positionable at a plurality of locations along the elongated body.

2. The leveling clip of claim 1, wherein the acoustically insulating material comprises a rubber material, a synthetic rubber, a softened PVC, EPDM, or neoprene.

3. The leveling clip of claim 1, wherein the acoustically insulating material comprises a durometer hardness between 20 and 60.

4. The leveling clip of claim 3, wherein the acoustically insulating material comprises a durometer hardness between 30 and 50.

5. The leveling clip of claim 1 wherein the elongated body comprises buttressed threads.

6. The leveling clip of claim 5 wherein the buttressed threads are 45/5 buttressed threads.

7. The leveling clip of claim 1, wherein the insert comprises a flange on one end thereof.

8. The leveling clip of claim 1, wherein the elongated body comprises an elongated non-threaded portion and a threaded portion.

9. The leveling clip of claim 8, wherein the elongated non-threaded portion comprises at least one flange on an end thereof.

10. The leveling clip of claim 9, wherein the at least one flange comprises a first flange disposed on one end of the insert adjacent to the elongated non-threaded portion and a second flange disposed on an opposite end of the elongated non-threaded portion.

11. The leveling clip of claim 10, wherein the elongated body comprises a threaded portion and a tapered portion.

12. The leveling clip of claim 1, wherein the mounting clip further comprises attachment flanges, the attachment flanges configured to position a furring channel.

13. A system for leveling and acoustically isolating a wall, floor, or ceiling, the system comprising:
a plurality of inserts formed from a flexible, acoustically insulating material, the inserts comprising a flanged end and an elongated body;
a plurality of mounting clips that include an aperture, the elongated body of the insert being received in the aperture, and the mounting clips being positionable at a plurality of locations along the elongated body of the inserts; and
a furring channel that attaches to two or more of the plurality of mounting clips.

14. The system of claim 13, further comprising fasteners that attach the plurality of inserts to the wall, wherein the furring channels are configured to support surface material of the wall, floor, or ceiling that is mounted to the furring channels, the position of the surface material and the furring channels being set based on positions of the mounting clips with respect to the elongated body of the inserts.

15. The system of claim 14, wherein the plurality of mounting clips comprise attachment flanges to which the furring channel attaches.

16. The system of claim 14, wherein the acoustically insulating material comprises a rubber material, a synthetic rubber, a softened PVC, EPDM, or neoprene.

17. The leveling clip of claim 14, wherein the acoustically insulating material comprises a durometer hardness between 30 and 50.

18. The leveling clip of claim 14, wherein the elongated body of the inserts comprises 45/5 buttressed threads.

19. The leveling clip of claim 14, wherein the inserts comprise a flange on one end thereof.

20. A method for leveling and acoustically isolating a wall, floor, or ceiling, the method comprising:
providing a plurality of inserts formed from a flexible, acoustically insulating material, the inserts comprising a flanged end and an elongated body;
providing a plurality of mounting clips that include an aperture;
inserting the elongated body of the inserts into the apertures of the mounting clips, the mounting clips being positionable at a plurality of locations along the elongated body of the inserts;
fastening the plurality of inserts onto the wall, floor, or ceiling;
attaching a furring channel to two or more of the plurality of mounting clips; and
mounting a surface material onto the furring channel, wherein positions of the surface material and the furring channels are set based on positions of the mounting clips with respect to the elongated body of the inserts.
